(19) United States
(12) Patent Application Publication
(10) Pub. No.: US 2026/0196833 A1
(43) Pub. Date: Jul. 9, 2026

(54) METHOD FOR PREDICTING PHOTOVOLATIC POWER AND APPARATUS, COMPUTER DEVICE AND STORAGE MEDIUM

(71) Applicants: THREE GORGES GROUP INDUSTRIAL DEVELOPMENT (BEIJING) CO., LTD, Beijing (CN); CHINA THREE GORGES CORPORATION, Wuhan (CN)

(72) Inventors: Tingyan LV, Wuhan (CN); Min CHEN, Wuhan (CN); Rong KANG, Wuhan (CN); Xinya LIU, Wuhan (CN); Kehan LI, Wuhan (CN)

(73) Assignees: THREE GORGES GROUP INDUSTRIAL DEVELOPMENT (BEIJING) CO., LTD, Beijing (CN); CHINA THREE GORGES CORPORATION, Wuhan (CN)

(21) Appl. No.: 19/083,453

(22) Filed: Mar. 19, 2025

(30) Foreign Application Priority Data
Mar. 22, 2024 (CN) 202410333267.6

(51) Int. Cl. H02J 3/00; H02J 101/24; H02J 103/30

(52) U.S. Cl. CPC H02J 3/004; H02J 2101/24; H02J 2103/30

(57) ABSTRACT

A method comprises: generating a second photovoltaic power prediction model by correcting a first photovoltaic power prediction model based on a correction coefficient; judging whether environment temperature information of a photovoltaic power generation component to be predicted meets preset requirement information; in the case that the environment temperature information does not meet the preset requirement information, determining an average battery temperature value of the photovoltaic power generation component to be predicted and a first relationship, the first relationship representing a relationship among a battery temperature, an environment temperature and an irradiance of the photovoltaic power generation component to be predicted; generating a third photovoltaic power prediction model by correcting the second photovoltaic power prediction model based on the average battery temperature value and the first relationship; and predicting a photovoltaic power value of the photovoltaic power generation component to be predicted by the third photovoltaic power prediction model.

### CROSS-REFERENCE TO RELATED APPLICATIONS

The present disclosure claims priority to Chinese patent application No. 202410333267.6 filed on Mar. 22, 2024 to China National Intellectual Property Administration, and entitled “method for predicting photovoltaic power and apparatus, computer device and storage medium”, the entire content of which is incorporated herein by reference.

### TECHNICAL FIELD

The present disclosure relates to the technical field of computers, and particularly to a method for predicting photovoltaic power and apparatus, a computer device and a storage medium.

### BACKGROUND

The utilization of renewable energy is one of the important ways to solve the problems of global energy scarcity and environmental pollution, and photovoltaic power generation is the most promising and convenient means in new energy development at present. The power of photovoltaic power generation is influenced by meteorological factors, and in addition, the process of converting light energy into electric energy by a photovoltaic component may be influenced by the device itself, so that photovoltaic output power has strong randomness and fluctuation. With the continuous increase of grid-connected capacity, the randomness and fluctuation of the photovoltaic output power pose a great threat to the safe and stable operation of a power grid, so that the accurate prediction of the photovoltaic output power is of great significance to improve the safety and stability of the power grid.

In the prior art, a neural network model is usually used to predict photovoltaic power, and the neural network model has the characteristics of high prediction accuracy and low data requirements. However, due to the low interpretability of the model, a generation cause of a power prediction result cannot be intuitively analyzed from a business level, so that it is difficult to achieve a linkage with an actual production and operation scenario. Therefore, there is an urgent need for a method for predicting photovoltaic power, which can explain contents and results of the model on the premise of ensuring the prediction accuracy, so as to achieve the linkage between the photovoltaic power prediction result and the actual production and operation scenario.

### SUMMARY

The technical problem to be solved by the present disclosure is to provide a method for predicting photovoltaic power and apparatus, a computer device and a storage medium, so as to solve the problem that a physical model has low prediction accuracy and cannot intuitively analyze a generation cause of a power prediction result from a business level, leading to a difficulty in linkage with an actual production and operation scenario, in the related art.

In order to solve the above technical problem, the technical solution used in the present disclosure is as follows.

A method for predicting photovoltaic power comprises the following steps of:
generating a second photovoltaic power prediction model by correcting a first photovoltaic power prediction model based on a correction coefficient; wherein the first photovoltaic power prediction model is constructed based on a battery temperature and an irradiance of a photovoltaic power generation component;
judging whether environment temperature information of the photovoltaic power generation component to be predicted meets preset requirement information; when the environment temperature information does not meet the preset requirement information, determining an average battery temperature value of the photovoltaic power generation component to be predicted and a first relationship, wherein the first relationship represents a relationship among the battery temperature, the environment temperature and the irradiance of the photovoltaic power generation component to be predicted;
generating a third photovoltaic power prediction model by correcting the second photovoltaic power prediction model based on the average battery temperature value and the first relationship;
predicting a photovoltaic power value of the photovoltaic power generation component to be predicted by the third photovoltaic power prediction model; and
according to a weather type of the photovoltaic power generation component to be predicted, determining a target weather correction coefficient from a plurality of weather correction coefficients.

Preferably, the photovoltaic power value is adjusted based on the target weather correction coefficient to obtain a target photovoltaic power value.

Preferably, before determining the target weather correction coefficient from the plurality of weather correction coefficients, the method comprises the following steps of:
acquiring multiple groups of data of the photovoltaic power generation component to be predicted under different weather types in advance, wherein each group of data comprise an installed capacity, an irradiance value, a battery temperature value and an actual power generation capacity under the corresponding weather type; and
inputting the installed capacity, the irradiance value, the battery temperature value and the actual power generation capacity under the corresponding weather type into the correction coefficient prediction model, and outputting the weather correction coefficient of the corresponding weather type.

Preferably, the correction coefficients comprise a dust influence coefficient, a light-induced attenuation loss coefficient and a surface reflection loss coefficient; and the correcting the first photovoltaic power prediction model based on the correction coefficient, and generating the second photovoltaic power prediction model, comprises:

$${p}_{p r e d 2} = ( 1 - {K}_{1} - {K}_{2} - {K}_{3} ) {p}_{p r e d T a r g} \times \frac{{G}_{m e a s}}{{G}_{T R C}} \times [ 1 + δ ( {T}_{1} - {T}_{T R C} ) ] ;$$

wherein, p_{pred2} represents a photovoltaic power value output by the second photovoltaic power prediction model, K₁ represents the dust influence coefficient, K₂ represents the light-induced attenuation loss coefficient in an initial state, K₃ represents the surface reflection loss coefficient, p_{predTarg} represents a photovoltaic rated power value of the photovoltaic power generation component, Gₘₑₐₛ represents an measured irradiance of the photovoltaic power generation component, G_{TRC} represents a rated irradiance of the photovoltaic power generation component, δ represents a power temperature correction coefficient, T₁ represents an measured battery temperature value of the photovoltaic power generation component, and T_{TRC} represents a rated battery temperature value of the photovoltaic power generation component.

Preferably, the generating the third photovoltaic power prediction model by correcting the second photovoltaic power prediction model based on the average battery temperature value and the first relationship, comprises:
performing primary correction on the second photovoltaic power prediction model based on the average battery temperature value; and
performing secondary correction on a result of the primary correction based on the first relationship, and generating the third photovoltaic power prediction model.

Preferably, the determining the average battery temperature value of the photovoltaic power generation component to be predicted, comprises:
acquiring all battery temperature values of the photovoltaic power generation component to be predicted in a preset time period;
removing battery temperature values with irradiance less than a preset threshold from all the battery temperature values; and
determining the average battery temperature value according to remaining battery temperature values.

The performing the primary correction on the second photovoltaic power prediction model based on the average battery temperature value, comprises:

$${p}_{p r e d 3} = ( 1 - {K}_{1} - {K}_{2} - {K}_{3} ) {p}_{p r e d T a r g} \times \frac{{G}_{m e a s}}{{G}_{T R C}} \times [ 1 + δ ( {T}_{2} - {T}_{T R C} ) ] ;$$

wherein, p_{pred3} represents a photovoltaic power value output by the result of the primary correction, K₁ represents the dust influence coefficient, K₂ represents the light-induced attenuation loss coefficient in an initial state, K₃ represents the surface reflection loss coefficient, p_{predTarg} represents a photovoltaic rated power value of the photovoltaic power generation component, Gₘₑₐₛ represents an measured irradiance of the photovoltaic power generation component, G_{TRC} represents a rated irradiance of the photovoltaic power generation component, δ represents a power temperature correction coefficient, T₂ represents the average battery temperature value, and T_{TRC} represents a rated battery temperature value of the photovoltaic power generation component.

Preferably, the first relationship is a linear fitting function; and the determining the first relationship of the photovoltaic power generation component to be predicted, comprises:
acquiring a plurality of battery temperature values of the photovoltaic power generation component to be predicted in a preset time period, a plurality of environment temperature values corresponding to the plurality of battery temperature values one by one, and a plurality of irradiance values corresponding to the plurality of battery temperature values one by one; and
obtaining the linear fitting function for representing that a difference between the battery temperature value and the environment temperature value has a linear relationship with the irradiance based on the plurality of battery temperature values, the plurality of environment temperature values and the plurality of irradiance values:

$${T}_{c e l l} = {T}_{a} + ( {T}_{N O C T} - {T}_{a , N O C T} ) \cdot ( H / {G}_{N O C T} ) \cdot ( 1 - ( η / τ a ) ) ;$$

wherein, T_{cell} represents the battery temperature value, Tₐ represents the environment temperature value, T_{NOCT} represents a battery piece temperature under an NOCT condition, T_{a,NOCT} represents an environment temperature under the NOCT condition, which is 20° C., H represents a solar irradiance on a matrix plane, and G_{NOCT} represents an irradiance under the NOCT condition, which is 800 W/m²; and η/τa represents 0.083/0.9, which is a default constant;
the performing the secondary correction on the result of the primary correction based on the first relationship, and generating the third photovoltaic power prediction model, comprises:

$${p}_{p r e d 4} = ( 1 - {K}_{1} - {K}_{2} - {K}_{3} ) {p}_{p r e d T a r g} \times \frac{{G}_{meas}}{{G}_{TRC}} \times [ 1 + δ ( {T}_{c e l l} - {T}_{T R C} ) ]$$

wherein, p_{pred4} represents a photovoltaic power value output by the second photovoltaic power prediction model, K₁ represents the dust influence coefficient, K₂ represents the light-induced attenuation loss coefficient in an initial state, K₃ represents the surface reflection loss coefficient, p_{predTarg} represents a photovoltaic rated power value of the photovoltaic power generation component, Gₘₑₐₛ represents an measured irradiance of the photovoltaic power generation component, G_{TRC} represents a rated irradiance of the photovoltaic power generation component, δ represents a power temperature correction coefficient, T_{TRC} represents a rated battery temperature value of the photovoltaic power generation component, and T_{cell} represents the linear fitting function.

Preferably, an apparatus for predicting photovoltaic power is provided, wherein the apparatus comprises a first model correction module configured for generating a second photovoltaic power prediction model by correcting a first photovoltaic power prediction model based on a correction coefficient; wherein the first photovoltaic power prediction model is constructed based on a battery temperature and an irradiance of a photovoltaic power generation component;
an information judgment module configured for judging whether environment temperature information of the photovoltaic power generation component to be predicted meets preset requirement information;
a data determination module configured for, when the environment temperature information does not meet the preset requirement information, determining an average battery temperature value of the photovoltaic power generation component to be predicted and a first relationship, wherein the first relationship represents a relationship among the battery temperature, the environment temperature and the irradiance of the photovoltaic power generation component to be predicted;
a second model correction module configured for generating a third photovoltaic power prediction model by correcting the second photovoltaic power prediction model based on the average battery temperature value and the first relationship; and
a photovoltaic power value prediction module configured for predicting a photovoltaic power value of the photovoltaic power generation component to be predicted by the third photovoltaic power prediction model.

Preferably, a computer device comprises a memory and a processor, wherein the memory and the processor are in communication connection with each other, the memory stores a computer instruction, and the processor executes the method for predicting photovoltaic power according to any one of the above items by executing the computer instruction.

Preferably, a computer-readable storage medium is provided, wherein the computer-readable storage medium stores a computer instruction thereon, and the computer instruction is used to enable a computer to execute the method for predicting photovoltaic power according to any one of the above items.

The method for predicting photovoltaic power and apparatus, the computer device and the storage medium provided by the present disclosure have the beneficial effects as follows.

1. According to the method for predicting photovoltaic power provided by the present disclosure, the target weather correction coefficient is selected according to the weather type, and the target photovoltaic power value is obtained by adjusting the photovoltaic power value based on the target weather correction coefficient, so that influences of different weather factors on the photovoltaic power generation component can be fully considered, thus greatly improving the prediction accuracy of photovoltaic power;

2. According to the method for predicting photovoltaic power provided by the present disclosure, by inputting the installed capacity, the irradiance value, the battery temperature value and the actual power generation capacity under the corresponding weather type into the correction coefficient prediction model, and outputting the weather correction coefficient of the corresponding weather type, the weather correction coefficients of different weather types can be determined through the correction coefficient prediction model and a sum of relevant data information of different weather types, and the photovoltaic power of the photovoltaic power generation component under different weather conditions can be effectively predicted;

3. According to the method for predicting photovoltaic power provided by the present disclosure, by correcting the first photovoltaic power prediction model based on the correction coefficient, and considering various factors affecting the power of photovoltaic power generation, which are namely the dust influence coefficient, the light-induced attenuation loss coefficient in the initial state and the surface reflection loss coefficient, the prediction accuracy of photovoltaic power can be improved;

4. According to the method for predicting photovoltaic power provided by the present disclosure, by averaging the measured battery temperatures of the photovoltaic power generation component, and linearly fitting the battery temperature and the irradiance of the photovoltaic power generation component, the two methods can jointly improve the accuracy of a prediction result of photovoltaic power generation of a power station;

5. According to the method for predicting photovoltaic power provided by the present disclosure, by removing the battery temperature value with the irradiance less than the preset threshold from the all battery temperature values, a weather difference caused by different geographical locations and a dynamic change of temperature of the photovoltaic power generation component with a change of environment at any time can be fully considered, so that the problem of low accuracy of predicting the photovoltaic power value under the condition is solved, so as to achieve the technical effect of improving the prediction accuracy; and by averaging the measured battery temperatures of the photovoltaic power generation component, the accuracy of the power prediction result of photovoltaic power generation of the power station can be further improved; and

6. according to the method for predicting photovoltaic power provided by the present disclosure, by constructing the linear fitting function for representing the correlation between the battery temperature and the irradiance, the relationship between the battery temperature and the irradiance can be more truly reflected, and by fully considering that the irradiance and the battery temperature are the main factors affecting the photovoltaic power, the prediction accuracy of power of photovoltaic power generation can be further improved.

### BRIEF DESCRIPTION OF DRAWINGS

The present disclosure is further described hereinafter with reference to the drawings and embodiments:

FIG. 1 is a flow chart of a method for predicting photovoltaic power according to an embodiment of the present disclosure;

FIG. 2 is a flow chart of another method for predicting photovoltaic power according to the embodiment of the present disclosure;

FIG. 3 is a flow chart of another method for predicting photovoltaic power according to the embodiment of the present disclosure;

FIG. 4 is a flow chart of another method for predicting photovoltaic power according to the embodiment of the present disclosure;

FIG. 5 is a flow chart of another method for predicting photovoltaic power according to the embodiment of the present disclosure;

FIG. 6 is a schematic diagram of outputting a weather correction coefficient by a linear regression model in the embodiment of the present disclosure;

FIG. 7 is a schematic diagram of a model performance after weather typing in the embodiment of the present disclosure;

FIG. 8 is a schematic diagram of outputting a weather correction coefficient by a linear regression model in the embodiment of the present disclosure;

FIG. 9 is a structural block diagram of an apparatus for predicting photovoltaic power according to the embodiment of the present disclosure; and

FIG. 10 is a schematic structural diagram of hardware of a computer device according to the embodiment of the present disclosure.

### DETAILED DESCRIPTION OF THE EMBODIMENTS

### First Embodiment

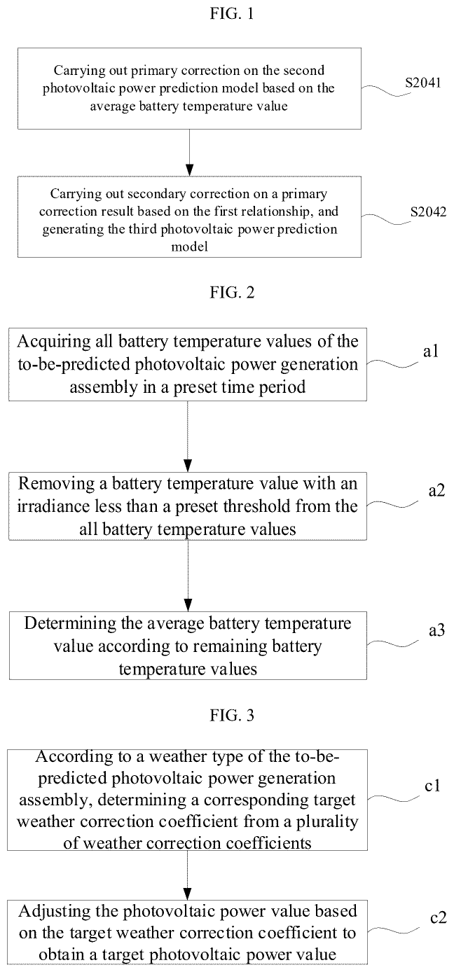

As shown in FIG. 1, a method for predicting photovoltaic power comprises:
generating a second photovoltaic power prediction model by correcting a first photovoltaic power prediction model based on a correction coefficient; wherein the first photovoltaic power prediction model is constructed based on a battery temperature and an irradiance of a photovoltaic power generation component;
judging whether environment temperature information of the photovoltaic power generation component to be predicted meets preset requirement information; in the case that the environment temperature information does not meet the preset requirement information, determining an average battery temperature value of the photovoltaic power generation component to be predicted and a first relationship, wherein the first relationship represents a relationship among the battery temperature, the environment temperature and the irradiance of the photovoltaic power generation component to be predicted;
generating a third photovoltaic power prediction model by correcting the second photovoltaic power prediction model based on the average battery temperature value and the first relationship;
predicting a photovoltaic power value of the photovoltaic power generation component to be predicted by the third photovoltaic power prediction model; and
according to a weather type of the photovoltaic power generation component to be predicted, determining a target weather correction coefficient from a plurality of weather correction coefficients.

Preferably, the photovoltaic power value is adjusted based on the target weather correction coefficient to obtain a target photovoltaic power value.

Preferably, before determining the target weather correction coefficient from the plurality of weather correction coefficients, the method comprises the following steps of:
acquiring multiple groups of data of the photovoltaic power generation component to be predicted under different weather types in advance, wherein each group of data comprise an installed capacity, an irradiance value, a battery temperature value and an actual power generation capacity under the corresponding weather type; and
inputting the installed capacity, the irradiance value, the battery temperature value and the actual power generation capacity under the corresponding weather type into the correction coefficient prediction model, and outputting the weather correction coefficient of the corresponding weather type.

Preferably, the correction coefficients comprise a dust influence coefficient, a light-induced attenuation loss coefficient and a surface reflection loss coefficient; and
the correcting the first photovoltaic power prediction model based on the correction coefficient, and generating the second photovoltaic power prediction model, comprises:

$${p}_{p r e d 2} = ( 1 - {K}_{1} - {K}_{2} - {K}_{3} ) {p}_{p r e d T a r g} \times \frac{{G}_{m e a s}}{{G}_{T R C}} \times [ 1 + δ ( {T}_{1} - {T}_{T R C} ) ] ;$$

wherein, p_{pred2} represents a photovoltaic power value output by the second photovoltaic power prediction model, K₁ represents the dust influence coefficient, K₂ represents the light-induced attenuation loss coefficient in an initial state, K₃ represents the surface reflection loss coefficient, p_{predTarg} represents a photovoltaic rated power value of the photovoltaic power generation component, Gₘₑₐₛ represents an measured irradiance of the photovoltaic power generation component, G_{TRC} represents a rated irradiance of the photovoltaic power generation component, δ represents a power temperature correction coefficient, T₁ represents an measured battery temperature value of the photovoltaic power generation component, and T_{TRC} represents a rated battery temperature value of the photovoltaic power generation component.

Preferably, the generating the third photovoltaic power prediction model by correcting the second photovoltaic power prediction model based on the average battery temperature value and the first relationship, comprises:
performing primary correction on the second photovoltaic power prediction model based on the average battery temperature value; and
performing secondary correction on a result of the primary correction based on the first relationship, and generating the third photovoltaic power prediction model.

Preferably, the determining the average battery temperature value of the photovoltaic power generation component to be predicted, comprises:
acquiring all battery temperature values of the photovoltaic power generation component to be predicted in a preset time period;
removing battery temperature values with irradiance less than a preset threshold from all the battery temperature values; and
determining the average battery temperature value according to remaining battery temperature values.

The performing the primary correction on the second photovoltaic power prediction model based on the average battery temperature value, comprises:

$${p}_{p r e d 3} = ( 1 - {K}_{1} - {K}_{2} - {K}_{3} ) {p}_{p r e d T a r g} \times \frac{{G}_{m e a s}}{{G}_{T R C}} \times [ 1 + δ ( {T}_{2} - {T}_{T R C} ) ] ;$$

wherein, p_{pred3} represents a photovoltaic power value output by the result of the primary correction, K₁ represents the dust influence coefficient, K₂ represents the light-induced attenuation loss coefficient in an initial state, K₃ represents the surface reflection loss coefficient, p_{predTarg} represents a photovoltaic rated power value of the photovoltaic power generation component, Gₘₑₐₛ represents an measured irradiance of the photovoltaic power generation component, G_{TRC} represents a rated irradiance of the photovoltaic power generation component, δ represents a power temperature correction coefficient, T₂ represents the average battery temperature value, and T_{TRC} represents a rated battery temperature value of the photovoltaic power generation component.

Preferably, the first relationship is a linear fitting function; and the determining the first relationship of the photovoltaic power generation component to be predicted, comprises:
acquiring a plurality of battery temperature values of the photovoltaic power generation component to be predicted in a preset time period, a plurality of environment temperature values corresponding to the plurality of battery temperature values one by one, and a plurality of irradiance values corresponding to the plurality of battery temperature values one by one; and
obtaining the linear fitting function for representing that a difference between the battery temperature value and the environment temperature value has a linear relationship with the irradiance based on the plurality of battery temperature values, the plurality of environment temperature values and the plurality of irradiance values:

$${T}_{c e l l} = {T}_{a} + ( {T}_{N O C T} - {T}_{a , N O C T} ) \cdot ( H / {G}_{N O C T} ) \cdot ( 1 - ( η / τ a ) ) ;$$

wherein, T_{cell} represents the battery temperature value, Tₐ represents the environment temperature value, T_{NOCT} represents a battery piece temperature under an NOCT condition, T_{a,NOCT} represents an environment temperature under the NOCT condition, which is 20° C., H represents a solar irradiance on a matrix plane, and G_{NOCT} represents an irradiance under the NOCT condition, which is 800 W/m²; and η/τa represents 0.083/0.9, which is a default constant;
the performing the secondary correction on the result of the primary correction based on the first relationship, and generating the third photovoltaic power prediction model, comprises:

$${p}_{p r e d 4} = ( 1 - {K}_{1} - {K}_{2} - {K}_{3} ) {p}_{p r e d T a r g} \times \frac{{G}_{meas}}{{G}_{TRC}} \times [ 1 + δ ( {T}_{c e l l} - {T}_{T R C} ) ] ;$$

wherein, p_{pred4} represents a photovoltaic power value output by the second photovoltaic power prediction model, K₁ represents the dust influence coefficient, K₂ represents the light-induced attenuation loss coefficient in an initial state, K₃ represents the surface reflection loss coefficient, p_{predTarg} represents a photovoltaic rated power value of the photovoltaic power generation component, Gₘₑₐₛ represents an measured irradiance of the photovoltaic power generation component, G_{TRC} represents a rated irradiance of the photovoltaic power generation component, δ represents a power temperature correction coefficient, T_{TRC} represents a rated battery temperature value of the photovoltaic power generation component, and T_{cell} represents the linear fitting function.

Preferably, an apparatus for predicting photovoltaic power is provided, wherein the apparatus comprises a first model correction module configured for generating a second photovoltaic power prediction model by correcting a first photovoltaic power prediction model based on a correction coefficient; wherein the first photovoltaic power prediction model is constructed based on a battery temperature and an irradiance of a photovoltaic power generation component;
an information judgment module configured for judging whether environment temperature information of the photovoltaic power generation component to be predicted meets preset requirement information;
a data determination module configured for determining an average battery temperature value of the photovoltaic power generation component to be predicted and a first relationship in the case that the environment temperature information does not meet the preset requirement information, wherein the first relationship represents a relationship among the battery temperature, the environment temperature and the irradiance of the photovoltaic power generation component to be predicted;
a second model correction module configured for generating a third photovoltaic power prediction model by correcting the second photovoltaic power prediction model based on the average battery temperature value and the first relationship; and
a photovoltaic power value prediction module configured for predicting a photovoltaic power value of the photovoltaic power generation component to be predicted by the third photovoltaic power prediction model.

Preferably, a computer device comprises a memory and a processor, wherein the memory and the processor are connected in communication with each other, a computer instruction is stored in the memory, and the processor executes the computer instruction, thereby executing the method for predicting photovoltaic power according to any one of the above items.

Preferably, a computer-readable storage medium is provided, wherein the computer-readable storage medium stores a computer instruction thereon, and the computer instruction is used to enable a computer to execute the method for predicting photovoltaic power according to any one of the above items.

### Second Embodiment

A method for predicting photovoltaic power based on a specific embodiment comprises the following steps.

In step S101, generating a second photovoltaic power prediction model by correcting a first photovoltaic power prediction model based on a correction coefficient.

Specifically, the first photovoltaic power prediction model is constructed based on a battery temperature and an irradiance of a photovoltaic power generation component, as shown in the following formula:

$${p}_{pred 1} = {p}_{p r e d T a r g} \times \frac{{G}_{m e a s}}{{G}_{TRC}} \times [ 1 + δ ( {T}_{1} - {T}_{T R C} ) ] ;$$

wherein, p_{pred1} represents a photovoltaic power value output by the first photovoltaic power prediction model, p_{predTarg} represents a photovoltaic rated power value of the photovoltaic power generation component, Gₘₑₐₛ represents an measured irradiance of the photovoltaic power generation component, G_{TRC} represents a rated irradiance of the photovoltaic power generation component, δ represents a power temperature correction coefficient, T₁ represents an measured battery temperature value of the photovoltaic power generation component, and T_{TRC} represents a rated battery temperature value of the photovoltaic power generation component.

More specifically, the second photovoltaic power prediction model is obtained by correcting the first photovoltaic power prediction model based on various correction coefficients, such as a dust influence coefficient, a light-induced attenuation loss coefficient in an initial state and a surface reflection loss coefficient, as shown in the following formula:

$${p}_{p r e d 2} = ( 1 - {K}_{1} - {K}_{2} - {K}_{3} ) {p}_{p r e d T a r g} \times \frac{{G}_{m e a s}}{{G}_{T R C}} \times [ 1 + δ ( {T}_{1} - {T}_{T R C} ) ] ;$$

wherein, p_{pred2} represents a photovoltaic power value output by the second photovoltaic power prediction model, K₁ represents the dust influence coefficient, K₂ represents the light-induced attenuation loss coefficient in an initial state, K₃ represents the surface reflection loss coefficient, p_{predTarg} represents a photovoltaic rated power value of the photovoltaic power generation component, Gₘₑₐₛ represents an measured irradiance of the photovoltaic power generation component, G_{TRC} represents a rated irradiance of the photovoltaic power generation component, δ represents a power temperature correction coefficient, T₁ represents an measured battery temperature value of the photovoltaic power generation component, and T_{TRC} represents a rated battery temperature value of the photovoltaic power generation component.

According to the present disclosure, by correcting the first photovoltaic power prediction model, the dust influence, the light-induced attenuation influence in the initial state of the photovoltaic power generation component and the surface reflection loss influence of the component are respectively substituted during the photovoltaic power prediction process, improving the accuracy of predicting photovoltaic power generation.

In step S102, judging whether environment temperature information of the photovoltaic power generation component to be predicted meets preset requirement information.

Specifically, a weather difference caused by different geographical locations of photovoltaic power stations and a dynamic change of temperature of the photovoltaic power generation component with a change of environment at any time are not considered in the related art of photovoltaic power prediction, so that the accuracy of predicting the photovoltaic power value under the condition is low, for example, a deviation of the photovoltaic power value predicted in a place at a low environment temperature is larger. In order to solve the above problem, the present disclosure needs to judge whether the environment temperature information of the photovoltaic power generation component to be predicted meets the preset requirement information first, for example, an average environment temperature of the photovoltaic power generation component to be predicted is less than the preset temperature threshold, and the preset temperature threshold may be set to be a corresponding temperature value according to different regional locations, which will not be specifically limited here in.

In step S103, in the case that the environment temperature information does not meet the preset requirement information, determining an average battery temperature value of the photovoltaic power generation component to be predicted and a first relationship.

Specifically, when the average environment temperature of the photovoltaic power generation component to be predicted is less than the preset temperature threshold, it is necessary to determine the average battery temperature value of the photovoltaic power generation component to be predicted and the first relationship; the average battery temperature value may be understood as an average battery temperature value in a preset time interval, the first relationship is a relationship among the battery temperature, the environment temperature and the irradiance of the photovoltaic power generation component to be predicted, and the relationship may be understood as a graph and/or a linear fitting function for representing a linear relationship among the battery temperature, the environment temperature and the irradiance.

In step S104, generating a third photovoltaic power prediction model by correcting the second photovoltaic power prediction model based on the average battery temperature value and the first relationship.

According to the present disclosure, by averaging the measured battery temperatures of the photovoltaic power generation component, and linearly fitting the battery temperature and the irradiance of the photovoltaic power generation component, the two methods both improve the accuracy of a prediction result of photovoltaic power generation of a power station.

In step S105, predicting a photovoltaic power value of the photovoltaic power generation component to be predicted using the third photovoltaic power prediction model.

Specifically, by inputting the irradiance of the photovoltaic power generation component to be predicted into the third photovoltaic power prediction model, the photovoltaic power value of the photovoltaic power generation component to be predicted may be output; and the irradiance herein is an average irradiance value, such as an average irradiance value per minute.

This embodiment provides a method for predicting photovoltaic power, and the flow comprises the following steps.

In step S201, generating a second photovoltaic power prediction model by correcting a first photovoltaic power prediction model based on a correction coefficient; wherein the first photovoltaic power prediction model is constructed based on a battery temperature and an irradiance of a photovoltaic power generation component. Details refer to the step S101 of the embodiment as shown in FIG. 1, which will not be repeated herein.

In step S202, judging whether environment temperature information of the photovoltaic power generation component to be predicted meets preset requirement information. Details refer to the step S102 of the embodiment as shown in FIG. 1, which will not be repeated herein.

In step S203, in the case that the environment temperature information does not meet the preset requirement information, determining an average battery temperature value of the photovoltaic power generation component to be predicted and a first relationship, wherein the first relationship represents a relationship among the battery temperature, the environment temperature and the irradiance of the photovoltaic power generation component to be predicted. Details refer to the step S103 of the embodiment as shown in FIG. 1, which will not be repeated herein.

In step S204, generating a third photovoltaic power prediction model by correcting the second photovoltaic power prediction model based on the average battery temperature value and the first relationship.

Specifically, as shown in FIG. 2, the above step S204 comprises step S2041 to step S2042, which are specifically as follows.

In step S2041, performing primary correction on the second photovoltaic power prediction model based on the average battery temperature value.

Specifically, as shown in FIG. 3, it is necessary to determine the average battery temperature value of the photovoltaic power generation component to be predicted before the step S2041, which comprises the following steps a1 to a3.

In step a1, obtaining all battery temperature values of the photovoltaic power generation component to be predicted in a preset time period. The preset time period may be set according to an actual situation, which will not be specifically limited herein.

In step a2, removing a battery temperature value with an irradiance less than a preset threshold from all the battery temperature values. Specifically, considering that when a solar irradiance of the photovoltaic power generation component is lower than 120 W/m², sunlight received by a surface of the component is in a diffuse reflection state, and a photon movement direction is disordered, the component cannot exert a photovoltaic effect, and has no power output, so that the preset threshold may be set to be 120 W/m².

In step a3, determining the average battery temperature value according to remaining battery temperature values.

Specifically, it may set several equal time intervals firstly during the process of determining the average battery temperature value, and then calculating the average battery temperature value in each time interval according to the remaining battery temperature values and a number of time intervals. For example, there are five time intervals, which respectively corresponding to battery temperature values y1, y2, y3, y4 and y5, and the average battery temperature value in each time interval is (y1+y2+y3+y4+y5)/5.

In above step S2041, the primary correction may be performed on the second photovoltaic power prediction model by the following formula and the average battery temperature value:

$${p}_{p r e d 3} = ( 1 - {K}_{1} - {K}_{2} - {K}_{3} ) {p}_{p r e d T a r g} \times \frac{{G}_{m e a s}}{{G}_{T R C}} \times [ 1 + δ ( {T}_{2} - {T}_{T R C} ) ] ;$$

wherein, p_{pred3} represents a photovoltaic power value output by the second photovoltaic power prediction model, K₁ represents the dust influence coefficient, K₂ represents the light-induced attenuation loss coefficient in an initial state, K₃ represents the surface reflection loss coefficient, p_{predTarg} represents a photovoltaic rated power value of the photovoltaic power generation component, Gₘₑₐₛ represents an measured irradiance of the photovoltaic power generation component, G_{TRC} represents a rated irradiance of the photovoltaic power generation component, δ represents a power temperature correction coefficient, T₂ represents the average battery temperature value, and T_{TRC} represents a rated battery temperature value of the photovoltaic power generation component.

According to the present disclosure, by performing the primary correction on the second photovoltaic power prediction model based on the average battery temperature value, a weather difference in different regions and a dynamic difference caused by a change of the temperature of the component with the environment on the photovoltaic power of the photovoltaic component can be fully considered for the photovoltaic power of the photovoltaic component, so that the accuracy of photovoltaic power prediction of the second photovoltaic power prediction model after primary correction is improved.

In step S2042, generating the third photovoltaic power prediction model by performing secondary correction on a result of the primary correction based on the first relationship.

Specifically, it is necessary to determine the first relationship of the photovoltaic power generation component to be predicted first before the step S2042, which comprises the following steps b1 to b2.

In step b1, obtaining a plurality of battery temperature values of the photovoltaic power generation component to be predicted in a preset time period, a plurality of environment temperature values corresponding to the plurality of battery temperature values one by one, and a plurality of irradiance values corresponding to the plurality of battery temperature values one by one.

Specifically, the preset time period may be set according to an actual situation, which will not be specifically limited herein, such as a quarter or a whole year. The battery temperature value may be an average battery temperature value per minute, the irradiance may be an average irradiance value per minute, and the environment temperature value may also be an average environment temperature value per minute. There is a one-to-one corresponding relationship among the three values, such as: average environment temperature value 1—average battery temperature value 1—average irradiance value 1 and average environment temperature value 2—average battery temperature value 2—average irradiance value 2.

More specifically, when the plurality of irradiance of the photovoltaic power generation component to be predicted corresponding to the plurality of battery temperature values in the preset time period are acquired, it is necessary to analyze and filter the irradiance, which means to remove data of non-working condition, such as low irradiance data of power outage maintenance, rainy weather and a condition with an irradiance below 120 W/m². In the process of removing the data of non-working condition, the irradiance may be processed by a box plot method, that is, the power generation capacity is divided into various sections, and the irradiance in various sections are made into a box plot to identify and filter the low irradiance data corresponding to relevant outliers. By using the irradiance data filtered by the box plot, a Cook distance of each irradiance data may be calculated, and if the Cook distance is larger than an average distance by a preset multiple, the irradiance data is considered as the outlier and needs to be filtered out.

In step b2, obtaining the linear fitting function for representing that a difference between the battery temperature value and the environment temperature value has a linear relationship with the irradiance based on the plurality of battery temperature values, the plurality of environment temperature values and the plurality of irradiance values.

Specifically, multiple groups of data are obtained, wherein each group of data comprise the battery temperature value, the irradiance corresponding to the battery temperature value and the environment temperature value corresponding to the battery temperature value, and after the data are filtered and screened, a large number of test samples are fitted for the screened data to obtain a correlation among the battery temperature value, the environment temperature value and the irradiance, that is, a difference between the photovoltaic battery temperature T_{cell} and the environment temperature Tₐ forms a linear relationship with the solar irradiance, and an actual working temperature of the photovoltaic battery may be calculated accordingly, which specifically refers to the following formula:

$${T}_{c e l l} = {T}_{a} + ( {T}_{N O C T} - {T}_{a , N O C T} ) \cdot ( H / {G}_{N O C T} ) \cdot ( 1 - ( η / τ a ) ) ;$$

wherein, Tₐ represents the environment temperature, in a unit of ° C., T_{NOCT} represents a battery piece junction temperature under an NOCT condition, in a unit of ° C., which is generally 45° C.+/−2° C., T_{a,NOCT} represents an environment temperature under the NOCT condition, which is 20° C., H represents a solar irradiance on a matrix plane, in a unit of W/m², G_{NOCT} represents an irradiance under the NOCT condition, in a unit of 800 W/m², and η/τa represents 0.083/0.9, which is a default constant. According to the above formula, it may be estimated that an actual temperature of a photovoltaic cell panel is 25° C. higher than the environment temperature.

In the above step S2042, generating the third photovoltaic power prediction model by performing the secondary correction on the result of the primary correction based on the following formula and the first relationship:

$${p}_{p r e d 4} = ( 1 - {K}_{1} - {K}_{2} - {K}_{3} ) {p}_{p r e d T a r g} \times \frac{{G}_{meas}}{{G}_{TRC}} \times [ 1 + δ ( {T}_{c e l l} - {T}_{T R C} ) ] ;$$

wherein, p_{pred4} represents a photovoltaic power value output by the second photovoltaic power prediction model, K₁ represents the dust influence coefficient, K₂ represents the light-induced attenuation loss coefficient in an initial state, K₃ represents the surface reflection loss coefficient, p_{predTarg} represents a photovoltaic rated power value of the photovoltaic power generation component, Gₘₑₐₛ represents an measured irradiance of the photovoltaic power generation component, G_{TRC} represents a rated irradiance of the photovoltaic power generation component, δ represents a power temperature correction coefficient, T_{TRC} represents a rated battery temperature value of the photovoltaic power generation component, and T_{cell} represents the linear fitting function.

Considering that the environment temperature, the irradiance and the battery temperature are the main factors affecting the photovoltaic power, the present disclosure obtains the correlation among the environment temperature, the irradiance and the battery temperature by fitting the large number of test samples, and performs the secondary correction on the result of the primary correction according to the correlation to obtain the third photovoltaic power prediction model, which can further improve the prediction accuracy of power of photovoltaic power generation.

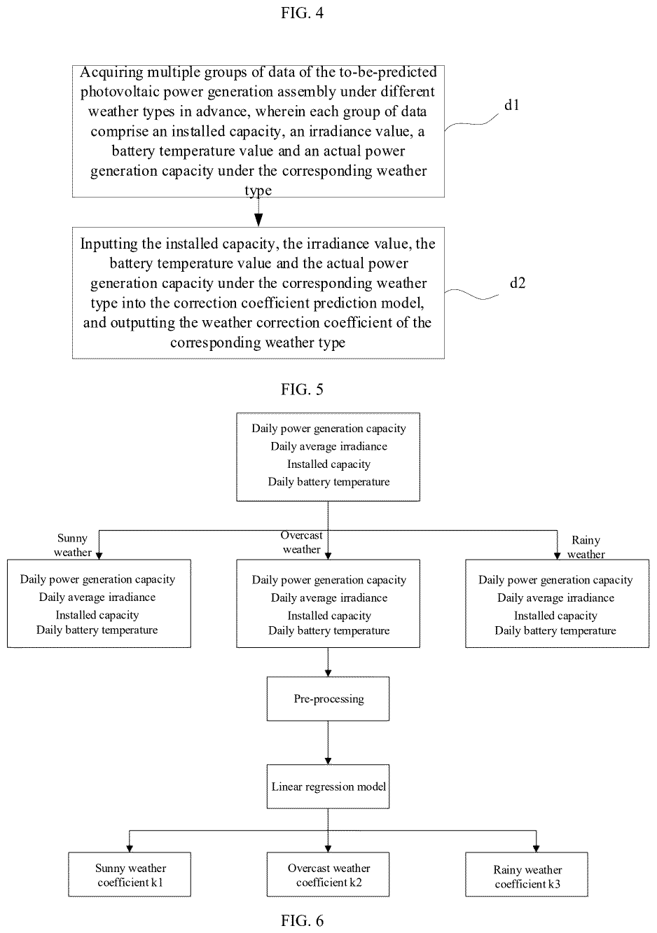

In some optional embodiments, as shown in FIG. 4, the method further comprises step c1 to step c2.

In step c1, according to a weather type of the photovoltaic power generation component to be predicted, determining a target weather correction coefficient from a plurality of weather correction coefficients.

Specifically, the weather type is mainly divided into a sunny weather, an overcast weather, such as a cloudy weather, an overcast weather and a sunny to cloudy weather, and a rainy and snowy weather, such as a cloudy to rainy weather, the weather correction coefficient also correspondingly comprises a sunny weather correction coefficient, an overcast weather correction coefficient and a rainy and snowy weather correction coefficient, and the corresponding weather correction coefficient may be selected according to the weather type to adjust the photovoltaic power value.

In step c2, adjusting the photovoltaic power value based on the target weather correction coefficient to obtain a target photovoltaic power value.

Specifically, by selecting the target weather correction coefficient according to the weather type to adjust the photovoltaic power value, the prediction accuracy of the target photovoltaic power value output can be improved.

In some optional embodiments, as shown in FIG. 5, before determining the target weather correction coefficient from the plurality of weather correction coefficients, the method further comprises step d1 to step d2.

In step d1, obtaining multiple groups of data of the photovoltaic power generation component to be predicted under different weather types in advance, wherein each group of data comprises an installed capacity, an irradiance value, a battery temperature value and an actual power generation capacity under the corresponding weather type. The photovoltaic power generation component to be predicted is a photovoltaic power generation component which does not access to centralized control data or has centralized control data quality failed to meet training requirements.

Specifically, the installed capacity represents the maximum power that the photovoltaic power generation component can output continuously; the irradiance value may be a daily average irradiance, which depends on a preset time period of acquisition of the group of data, wherein when the preset time period of acquisition is each day, the irradiance value is a daily average irradiance, and when the preset time period of acquisition is each month, the irradiance value is a monthly average irradiance; the battery temperature value may be a highest battery temperature, a daily average battery temperature or a monthly average battery temperature; and the actual power generation capacity is an actual power generation capacity of the photovoltaic power generation component.

In step d2, inputting the installed capacity, the irradiance value, the battery temperature value and the actual power generation capacity under the corresponding weather type into the correction coefficient prediction model, and outputting the weather correction coefficient of the corresponding weather type.

Specifically, the correction coefficient prediction model may obtain the corresponding weather correction coefficient by linear regression through the linear regression model; and the correction coefficient prediction model is expressed as follows:

$${W}_{a d j} = k \times {P}_{p r e d T a r g} \frac{{G}_{m e a s}}{1000} \times ( 1 - 0.44 \% \times {T}_{a} ) \times 24 ;$$

wherein, W_{adj} represents the actual power generation capacity of the photovoltaic power generation component, k represents the weather correction coefficient of the corresponding weather type, Gₘₑₐₛ represents the irradiance, such as the daily average irradiance, and Tₐ represents the battery temperature value, such as the maximum battery temperature value.

More specifically, as shown in FIG. 6, daily installed capacities, daily average irradiance, daily power generation capacities and battery temperatures of the sunny weather, the overcast weather and the rainy weather are respectively acquired first; and then pre-processed, such as Cook distance and box plot processing, to remove the outliers; and finally, each group of processed data are input into the linear regression model to obtain corresponding weather correction coefficients, such as a sunny weather coefficient k1, an overcast weather coefficient k2 and a rainy weather coefficient k3.

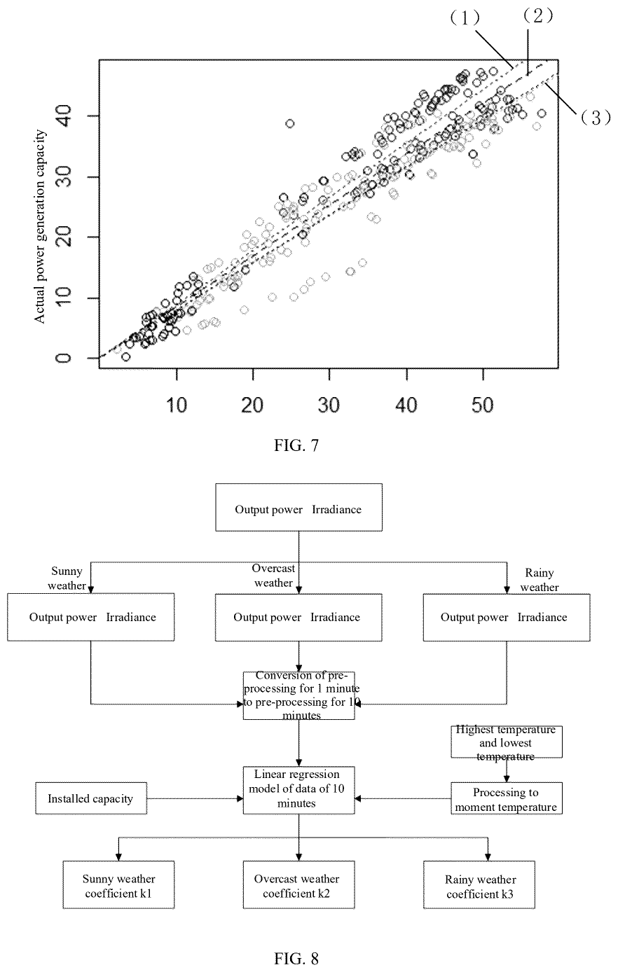

The weather correction coefficient of corresponding weather type is output through the above correction coefficient prediction model, and a prediction result may be linked with an actual production scenario for investigation, thus further improving the accuracy of the model by considering weather conditions. Considering training in different weather to optimize the linear model, a model performance after weather classification is as shown in FIG. 7 and Table 1, and the weather is divided into three types of correction coefficients of (1) the sunny weather, (2) the cloudy/overcast/sunny to cloudy weather and (3) the rainy/snowy/cloudy to rainy weather. It can be seen from Table 1 that the sunny weather coefficient is relatively high, the overcast/cloudy coefficient is relatively low, and the rainy/snowy coefficient is the lowest, and it can be seen from FIG. 7 that the power generation capacity corresponding to the sunny weather is the highest, the power generation capacity corresponding to the overcast/cloudy weather is relatively low, and the power generation capacity corresponding to the rainy/snowy weather is the lowest. Thus, it can be seen that, by optimizing the linear model with different weather coefficients, the photovoltaic power prediction result can be linked with the actual production and operation scenario, that is, the different weather type, so as to improve the accuracy of the prediction result.

TABLE 1
Model performance after weather classification

| | | Sunny | Overcast/ | Rainy/ |
|---|---|---|---|---|
| | | weather | cloudy | snowy |
| Scope of data | All data | (1) | weather (2) | weather (3) |
| Coefficient | 0.841526 | 0.88785 | 0.78484 | 0.79188 |
| Data volume | 296 | 106 | 142 | 42 |
| MSE | 18.36095 | 18.54569 | 16.02396 | 3.070829 |

In some optional embodiments, as shown in FIG. 8, when the photovoltaic power generation component to be predicted is a photovoltaic power generation component which can use the centralized control data but cannot use inverter operation data, before determining the target weather correction coefficient from the plurality of weather correction coefficients, the method further comprises the following steps.

In step e1, obtaining multiple groups of centralized control data of the photovoltaic power generation component to be predicted under different weather types in advance, wherein each group of centralized control data comprise output power and an irradiance under the corresponding weather type.

In step e2, preprocessing the multiple groups of centralized control data respectively, and an average irradiance value per minute is converted into an average irradiance value per 10 minutes; and the processed output power and irradiance, the installed capacity and a moment temperature obtained by processing the battery temperature are input into the linear regression model, and the corresponding sunny weather coefficient k1, overcast weather coefficient k2 and rainy weather coefficient k3 are output.

Specifically, when the photovoltaic power generation component to be predicted is a photovoltaic power generation component which may use the centralized control data and the inverter operation data, the installed capacity data may be replaced by an operation capacity of inverter data, and other steps are the same as the above steps e1 and e2.

The embodiment further provides an apparatus for predicting photovoltaic power, and the apparatus is used to realize the above embodiment and preferred embodiments, which has been described and will not be repeated herein. As used below, the term “module” may be a combination of software and/or hardware that implements a predetermined function. Although the apparatus described in the following embodiment is preferably implemented by software, the implementation by hardware, or a combination of software and hardware, is also possible and conceived.

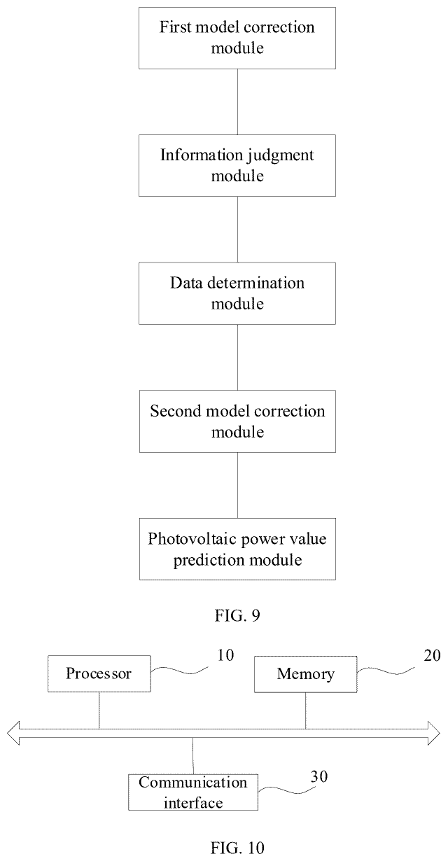

The embodiment provides an apparatus for predicting photovoltaic power, which, as shown in FIG. 9, comprises:
a first model correction module configured for generating a second photovoltaic power prediction model by correcting a first photovoltaic power prediction model based on a correction coefficient; wherein the first photovoltaic power prediction model is constructed based on a battery temperature and an irradiance of a photovoltaic power generation component;
an information judgment module configured for judging whether environment temperature information of the photovoltaic power generation component to be predicted meets preset requirement information;
a data determination module configured for, when the environment temperature information does not meet the preset requirement information, determining an average battery temperature value of the photovoltaic power generation component to be predicted and a first relationship, wherein the first relationship represents a relationship among the battery temperature, the environment temperature and the irradiance of the photovoltaic power generation component to be predicted;
a second model correction module configured for generating a third photovoltaic power prediction model by correcting the second photovoltaic power prediction model based on the average battery temperature value and the first relationship; and
a photovoltaic power value prediction module configured for predicting a photovoltaic power value of the photovoltaic power generation component to be predicted by the third photovoltaic power prediction model.

In some optional embodiments, the apparatus further comprises:
a target weather correction coefficient determination module configured for, according to a weather type of the photovoltaic power generation component to be predicted, determining a target weather correction coefficient from a plurality of weather correction coefficients; and
a photovoltaic power value adjustment module configured for, adjusting the photovoltaic power value based on the target weather correction coefficient to obtain a target photovoltaic power value.

In some optional embodiments, before determining the target weather correction coefficient from the plurality of weather correction coefficients, the apparatus further comprises:
a data acquisition module configured for acquiring multiple groups of data of the photovoltaic power generation component to be predicted under different weather types in advance, wherein each group of data comprise an installed capacity, an irradiance value, a battery temperature value and an actual power generation capacity under the corresponding weather type; and
a weather correction coefficient output module configured for inputting the installed capacity, the irradiance value, the battery temperature value and the actual power generation capacity under the corresponding weather type into the correction coefficient prediction model, and outputting the weather correction coefficient of the corresponding weather type.

In some optional embodiments, the correction coefficients comprise a dust influence coefficient, a light-induced attenuation loss coefficient and a surface reflection loss coefficient; and
the correcting the first photovoltaic power prediction model based on the correction coefficient, and generating the second photovoltaic power prediction model, comprises:

$${p}_{p r e d 2} = ( 1 - {K}_{1} - {K}_{2} - {K}_{3} ) {p}_{p r e d T a r g} \times \frac{{G}_{m e a s}}{{G}_{T R C}} \times [ 1 + δ ( {T}_{1} - {T}_{T R C} ) ] ;$$

wherein, p_{pred2} represents a photovoltaic power value output by the second photovoltaic power prediction model, K₁ represents the dust influence coefficient, K₂ represents the light-induced attenuation loss coefficient in an initial state, K₃ represents the surface reflection loss coefficient, p_{predTarg} represents a photovoltaic rated power value of the photovoltaic power generation component, Gₘₑₐₛ represents an measured irradiance of the photovoltaic power generation component, G_{TRC} represents a rated irradiance of the photovoltaic power generation component, δ represents a power temperature correction coefficient, T₁ represents an measured battery temperature value of the photovoltaic power generation component, and T_{TRC} represents a rated battery temperature value of the photovoltaic power generation component.

In some optional embodiments, the second model correction module comprises:
a first correction unit configured for performing primary correction on the second photovoltaic power prediction model based on the average battery temperature value; and
a second correction unit configured for performing secondary correction on a result of the primary correction based on the first relationship, and generating the third photovoltaic power prediction model.

In some optional embodiments, the data determination module comprises:
a battery temperature value acquisition unit configured for acquiring all battery temperature values of the photovoltaic power generation component to be predicted in a preset time period;
a battery temperature value removal unit configured for removing battery temperature values with irradiance less than a preset threshold from all the battery temperature values; and
an average battery temperature value determination unit configured for determining the average battery temperature value according to remaining battery temperature values.

The primary correction unit comprises:

$${p}_{p r e d 3} = ( 1 - {K}_{1} - {K}_{2} - {K}_{3} ) {p}_{p r e d T a r g} \times \frac{{G}_{m e a s}}{{G}_{T R C}} \times [ 1 + δ ( {T}_{2} - {T}_{TRC} ) ] ;$$

wherein, p_{pred3} represents a photovoltaic power value output by the result of the primary correction, K₁ represents the dust influence coefficient, K₂ represents the light-induced attenuation loss coefficient in an initial state, K₃ represents the surface reflection loss coefficient, p_{predTarg} represents a photovoltaic rated power value of the photovoltaic power generation component, Gₘₑₐₛ represents an measured irradiance of the photovoltaic power generation component, G_{TRC} represents a rated irradiance of the photovoltaic power generation component, δ represents a power temperature correction coefficient, T₂ represents the average battery temperature value, and T_{TRC} represents a rated battery temperature value of the photovoltaic power generation component.

In some optional embodiments, the first relationship is a linear fitting function; and the data determination module comprises:
a data acquisition unit configured for acquiring a plurality of battery temperature values of the photovoltaic power generation component to be predicted in a preset time period, a plurality of environment temperature values corresponding to the plurality of battery temperature values one by one, and a plurality of irradiance values corresponding to the plurality of battery temperature values one by one; and
a linear fitting function determination unit configured for obtaining the linear fitting function for representing that a difference between the battery temperature value and the environment temperature value has a linear relationship with the irradiance based on the plurality of battery temperature values, the plurality of environment temperature values and the plurality of irradiance values.

The linear fitting function comprises:

$${T}_{c e l l} = {T}_{a} + ( {T}_{N O C T} - {T}_{a , N O C T} ) \cdot ( H / {G}_{N O C T} ) \cdot ( 1 - ( η / τ a ) ) ;$$

wherein, T_{cell} represents the battery temperature value, Tₐ represents the environment temperature value, T_{NOCT} represents a battery piece temperature under an NOCT condition, T_{a,NOCT} represents an environment temperature under the NOCT condition, which is 20° C., H represents a solar irradiance on a matrix plane, and G_{NOCT} represents an irradiance under the NOCT condition, which is 800 W/m²; and η/τa represents 0.083/0.9, which is a default constant.

The second correction unit comprises:

$${p}_{p r e d 4} = ( 1 - {K}_{1} - {K}_{2} - {K}_{3} ) {p}_{p r e d T a r g} \times \frac{{G}_{m e a s}}{{G}_{T R C}} \times [ 1 + δ ( {T}_{c e l l} - {T}_{T R C} ) ] ;$$

wherein, p_{pred4} represents a photovoltaic power value output by the second photovoltaic power prediction model, K₁ represents the dust influence coefficient, K₂ represents the light-induced attenuation loss coefficient in an initial state, K₃ represents the surface reflection loss coefficient, p_{predTarg} represents a photovoltaic rated power value of the photovoltaic power generation component, Gₘₑₐₛ represents an measured irradiance of the photovoltaic power generation component, G_{TRC} represents a rated irradiance of the photovoltaic power generation component, δ represents a power temperature correction coefficient, T_{TRC} represents a rated battery temperature value of the photovoltaic power generation component, and T_{cell} represents the linear fitting function.

Further functional descriptions of the above modules and units are the same as those of the above corresponding embodiments, which will not be repeated herein.

The embodiment of the present disclosure further provides a computer device, which is provided with the apparatus for predicting photovoltaic power above as shown in FIG. 9.

FIG. 10 is a schematic structural diagram of a computer device provided by an optional embodiment of the present disclosure. As shown in FIG. 10, the computer device comprises one or more processors 10, a memory 20 and interfaces for connecting various components, including a high-speed interface and a low-speed interface. The various components are interconnected using different buses and may be mounted on a common motherboard or otherwise as desired. The processor may process instructions for execution within the computer device, including instructions stored in the memory or on the memory to display graphical information of a Graphical User Interface (GUI) on an external input/output device (such as a display device coupled to the interface). In some optional embodiments, multiple processors and/or multiple buses may be used with multiple memories and multiple memories, if necessary. Similarly, multiple computer devices may be connected, and each device provides some necessary operations (for example, as an array of servers, a group of blade servers, or a multiprocessor system). In FIG. 10, one processor 10 is taken as an example.

The processor 10 may be a central processing unit, a network processor or a combination thereof. The processor 10 may also further include a hardware chip. The above-mentioned hardware chip may be an application-specific integrated circuit, a programmable logic device or a combination thereof. The above-mentioned programmable logic device may be a complex programmable logic device, a field programmable logic gate array, a generic array logic or any combination thereof.

The memory 20 stores an instruction executable by the at least one processor 10 to enable the at least one processor 10 to execute the method shown in the above embodiments.

The memory 20 may include a program storage region and a data storage region, wherein the program storage region may store application programs required by an operating system and at least one function. The data storage area may store data and the like created according to the use of the computer device. In addition, the memory 20 may include a high-speed random access memory, and may also include a non-transitory memory, such as at least one disk memory device, a flash memory device, or other non-transitory solid state memory device. In some optional embodiments, the memory 20 may optionally comprise a memory remotely arranged relative to the processor 10, and these remote memories may be connected to the computer device through a network. Examples of the networks above include, but are not limited to, the Internet, intranet, local area networks, mobile communication networks, and combinations thereof.

The memory 20 may include a volatile memory, for example, a random access memory. The memory may also include a non-volatile memory, such as a flash memory, hard disk or a solid state hard disk. The memory 20 may also include a combination of the various memories above.

The computer device further includes a communication interface 30 for communication of the computer device with other devices or communication networks.

The embodiments of the present disclosure further provide a computer-readable storage medium and the method according to the embodiments of the present disclosure can be implemented in hardware or firmware, or can be recorded in a storage medium, or can be implemented in computer codes originally stored in a remote storage medium or a non-temporary machine-readable storage medium and to be stored in a local storage medium downloaded through a network, so that the method described herein can be processed by such software stored on a storage medium using a general purpose computer, a special purpose processor, or programmable or special purpose hardware. The storage medium may be a magnetic disk, an optical disk, a read-only memory, a random access memory, a flash memory, a hard disk or a solid state hard disk. Further, the storage medium may also include a combination of the various memories mentioned above. It can be understood that a computer, a processor, a microprocessor controller or programmable hardware includes a storage component that can store or receive software or computer codes, and when the software or the computer code is accessed and executed by the computer, the processor or the hardware, the method shown in the above embodiments is realized.

Although the embodiments of the present disclosure are described with reference to the drawings, various modifications and variations may be made by those skilled in the art without departing from the spirit and scope of the present disclosure, and such modifications and variations are all included within the scope defined by the appended claims.

1. A method for predicting photovoltaic power, comprising:
generating a second photovoltaic power prediction model by correcting a first photovoltaic power prediction model based on a correction coefficient, comprising:
$${p}_{p r e d 2} = ( 1 - {K}_{1} - {K}_{2} - {K}_{3} ) {p}_{p r e d T a r g} \times \frac{{G}_{m e a s}}{{G}_{T R C}} \times [ 1 + δ ( {T}_{1} - {T}_{TRC} ) ] ;$$
wherein, p_{pred2} represents a photovoltaic power value output by the second photovoltaic power prediction model, K₁ represents a dust influence coefficient, K₂ represents a light-induced attenuation loss coefficient in an initial state, K₃ represents a surface reflection loss coefficient, p_{predTarg} represents a photovoltaic rated power value of a photovoltaic power generation component, Gₘₑₐₛ represents a measured irradiance of the photovoltaic power generation component, G_{TRC} represents a rated irradiance of the photovoltaic power generation component, δ represents a power temperature correction coefficient, T₁ represents a measured battery temperature value of the photovoltaic power generation component, and T_{TRC} represents a rated battery temperature value of the photovoltaic power generation component;
wherein the first photovoltaic power prediction model is constructed based on a battery temperature and an irradiance of the photovoltaic power generation component;
judging whether environment temperature information of the photovoltaic power generation component to be predicted meets preset requirement information; in a case that the environment temperature information does not meet the preset requirement information, determining an average battery temperature value of the photovoltaic power generation component to be predicted and a first relationship, wherein the first relationship represents a relationship among the battery temperature, an environment temperature and the irradiance of the photovoltaic power generation component to be predicted;
generating a third photovoltaic power prediction model by correcting the second photovoltaic power prediction model based on the average battery temperature value and the first relationship, comprising:
performing primary correction on the second photovoltaic power prediction model based on the average battery temperature value, wherein determining the average battery temperature value of the photovoltaic power generation component to be predicted, comprises:
acquiring all battery temperature values of the photovoltaic power generation component to be predicted in a preset time period;
removing battery temperature values with irradiance less than a preset threshold from all the battery temperature values; and
determining the average battery temperature value according to remaining battery temperature values;
performing the primary correction on the second photovoltaic power prediction model based on the average battery temperature value, comprises:
$${p}_{p r e d 3} = ( 1 - {K}_{1} - {K}_{2} - {K}_{3} ) {p}_{p r e d T a r g} \times \frac{{G}_{m e a s}}{{G}_{T R C}} \times [ 1 + δ ( {T}_{2} - {T}_{TRC} ) ] ;$$
wherein, p_{pred3} represents a photovoltaic power value output by a result of the primary correction, K₁ represents the dust influence coefficient, K₂ represents the light-induced attenuation loss coefficient in the initial state, K₃ represents the surface reflection loss coefficient, p_{predTarg} represents the photovoltaic rated power value of the photovoltaic power generation component, Gₘₑₐₛ represents the measured irradiance of the photovoltaic power generation component, G_{TRC} represents the rated irradiance of the photovoltaic power generation component, δ represents the power temperature correction coefficient, T₂ represents the average battery temperature value, and T_{TRC} represents the rated battery temperature value of the photovoltaic power generation component;
performing secondary correction on the result of the primary correction based on the first relationship, and generating the third photovoltaic power prediction model, wherein the first relationship is a linear fitting function; and determining the first relationship of the photovoltaic power generation component to be predicted comprises:
acquiring a plurality of battery temperature values of the photovoltaic power generation component to be predicted in the preset time period, a plurality of environment temperature values corresponding to the plurality of battery temperature values one by one, and a plurality of irradiance values corresponding to the plurality of battery temperature values one by one; and
obtaining the linear fitting function for representing that a difference between the battery temperature value and the environment temperature value has a linear relationship with the irradiance based on the plurality of battery temperature values, the plurality of environment temperature values and the plurality of irradiance values:
$${T}_{c e l l} = {T}_{a} + ( {T}_{N O C T} - {T}_{a , N O C T} ) \cdot ( H / {G}_{N O C T} ) \cdot ( 1 - ( η / τ a ) ) ;$$
wherein, T_{cell} represents the battery temperature value, Tₐ represents the environment temperature value, T_{NOCT} represents a battery piece temperature under an NOCT condition, T_{a,NOCT} represents an environment temperature under the NOCT condition, which is 20° C., H represents a solar irradiance on a matrix plane, and G_{NOCT} represents an irradiance under the NOCT condition, which is 800 W/m²; and η/τa represents 0.083/0.9, which is a default constant;
performing the secondary correction on the result of the primary correction based on the first relationship, and generating the third photovoltaic power prediction model, comprises:
$${p}_{p r e d 4} = ( 1 - {K}_{1} - {K}_{2} - {K}_{3} ) {p}_{p r e d T a r g} \times \frac{{G}_{m e a s}}{{G}_{T R C}} \times [ 1 + δ ( {T}_{c e l l} - {T}_{T R C} ) ] ;$$
wherein, p_{pred4} represents the photovoltaic power value output by the second photovoltaic power prediction model, K₁ represents the dust influence coefficient, K₂ represents the light-induced attenuation loss coefficient in an initial state, K₃ represents the surface reflection loss coefficient, p_{predTarg} represents the photovoltaic rated power value of the photovoltaic power generation component, Gₘₑₐₛ represents the measured irradiance of the photovoltaic power generation component, G_{TRC} represents the rated irradiance of the photovoltaic power generation component, δ represents the power temperature correction coefficient, T_{TRC} represents the rated battery temperature value of the photovoltaic power generation component, and T_{cell} represents the linear fitting function;
predicting a photovoltaic power value of the photovoltaic power generation component to be predicted using the third photovoltaic power prediction model; and
according to a weather type of the photovoltaic power generation component to be predicted, determining a target weather correction coefficient from a plurality of weather correction coefficients.

2. The method for predicting photovoltaic power according to claim 1, wherein the photovoltaic power value is adjusted based on the target weather correction coefficient to obtain a target photovoltaic power value.

3. The method for predicting photovoltaic power according to claim 2, wherein, before determining the target weather correction coefficient from the plurality of weather correction coefficients, the method comprises:
acquiring multiple groups of data of the photovoltaic power generation component to be predicted under different weather types in advance, wherein each group of data comprises an installed capacity, an irradiance value, a battery temperature value and an actual power generation capacity under a corresponding weather type; and
determining the target weather correction coefficient of a corresponding weather type by inputting the installed capacity, the irradiance value, the battery temperature value and the actual power generation capacity under the corresponding weather type into a correction coefficient prediction model.

4. An apparatus for predicting photovoltaic power, wherein the apparatus comprises
a first model correction module configured for generating a second photovoltaic power prediction model by correcting a first photovoltaic power prediction model based on a correction coefficient; wherein the first photovoltaic power prediction model is constructed based on a battery temperature and an irradiance of a photovoltaic power generation component, wherein generating the second photovoltaic power prediction model by correcting the first photovoltaic power prediction model based on a correction coefficient comprises:
$${p}_{p r e d 2} = ( 1 - {K}_{1} - {K}_{2} - {K}_{3} ) {p}_{p r e d T a r g} \times \frac{{G}_{m e a s}}{{G}_{T R C}} \times [ 1 + δ ( {T}_{1} - {T}_{TRC} ) ] ;$$
wherein, p_{pred2} represents a photovoltaic power value output by the second photovoltaic power prediction model, K₁ represents a dust influence coefficient, K₂ represents a light-induced attenuation loss coefficient in an initial state, K₃ represents a surface reflection loss coefficient, p_{predTarg} represents a photovoltaic rated power value of the photovoltaic power generation component, Gₘₑₐₛ represents a measured irradiance of the photovoltaic power generation component, G_{TRC} represents a rated irradiance of the photovoltaic power generation component, δ represents a power temperature correction coefficient, T₁ represents a measured battery temperature value of the photovoltaic power generation component, and T_{TRC} represents a rated battery temperature value of the photovoltaic power generation component
an information judgment module configured for judging whether environment temperature information of the photovoltaic power generation component to be predicted meets preset requirement information;
a data determination module configured for determining an average battery temperature value of the photovoltaic power generation component to be predicted and a first relationship in the case that the environment temperature information does not meet the preset requirement information, wherein the first relationship represents a relationship among the battery temperature, a environment temperature and the irradiance of the photovoltaic power generation component to be predicted;
a second model correction module configured for generating a third photovoltaic power prediction model by correcting the second photovoltaic power prediction model based on the average battery temperature value and the first relationship, which comprises:
performing primary correction on the second photovoltaic power prediction model based on the average battery temperature value, wherein determining the average battery temperature value of the photovoltaic power generation component to be predicted, comprises:
acquiring all battery temperature values of the photovoltaic power generation component to be predicted in a preset time period;
removing battery temperature values with irradiance less than a preset threshold from all the battery temperature values; and
determining the average battery temperature value according to remaining battery temperature values;
performing the primary correction on the second photovoltaic power prediction model based on the average battery temperature value, comprises:
$${p}_{p r e d 3} = ( 1 - {K}_{1} - {K}_{2} - {K}_{3} ) {p}_{p r e d T a r g} \times \frac{{G}_{m e a s}}{{G}_{T R C}} \times [ 1 + δ ( {T}_{2} - {T}_{TRC} ) ] ;$$
wherein, p_{pred3} represents a photovoltaic power value output by a result of the primary correction, K₁ represents the dust influence coefficient, K₂ represents the light-induced attenuation loss coefficient in the initial state, K₃ represents the surface reflection loss coefficient, p_{predTarg} represents the photovoltaic rated power value of the photovoltaic power generation component, Gₘₑₐₛ represents the measured irradiance of the photovoltaic power generation component, G_{TRC} represents the rated irradiance of the photovoltaic power generation component, δ represents the power temperature correction coefficient, T₂ represents the average battery temperature value, and T_{TRC} represents the rated battery temperature value of the photovoltaic power generation component;
performing secondary correction on the result of the primary correction based on the first relationship, and generating the third photovoltaic power prediction model, wherein the first relationship is a linear fitting function; and determining the first relationship of the photovoltaic power generation component to be predicted comprises:
acquiring a plurality of battery temperature values of the photovoltaic power generation component to be predicted in the preset time period, a plurality of environment temperature values corresponding to the plurality of battery temperature values one by one, and a plurality of irradiance values corresponding to the plurality of battery temperature values one by one; and
obtaining the linear fitting function for representing that a difference between the battery temperature value and the environment temperature value has a linear relationship with the irradiance based on the plurality of battery temperature values, the plurality of environment temperature values and the plurality of irradiance values:
$${T}_{c e l l} = {T}_{a} + ( {T}_{N O C T} - {T}_{a , N O C T} ) \cdot ( H / {G}_{N O C T} ) \cdot ( 1 - ( η / τ a ) ) ;$$
wherein, T_{cell} represents the battery temperature value, Tₐ represents the environment temperature value, T_{NOCT} represents a battery piece temperature under an NOCT condition, T_{a,NOCT} represents an environment temperature under the NOCT condition, which is 20° C., H represents a solar irradiance on a matrix plane, and G_{NOCT} represents an irradiance under the NOCT condition, which is 800 W/m²; and η/τa represents 0.083/0.9, which is a default constant;
performing the secondary correction on the result of the primary correction based on the first relationship, and generating the third photovoltaic power prediction model, comprises:
$${p}_{p r e d 4} = ( 1 - {K}_{1} - {K}_{2} - {K}_{3} ) {p}_{p r e d T a r g} \times \frac{{G}_{m e a s}}{{G}_{T R C}} \times [ 1 + δ ( {T}_{c e l l} - {T}_{T R C} ) ] ;$$
wherein, p_{pred4} represents the photovoltaic power value output by the second photovoltaic power prediction model, K₁ represents the dust influence coefficient, K₂ represents the light-induced attenuation loss coefficient in the initial state, K₃ represents the surface reflection loss coefficient, p_{predTarg} represents the photovoltaic rated power value of the photovoltaic power generation component, Gₘₑₐₛ represents the measured irradiance of the photovoltaic power generation component, G_{TRC} represents the rated irradiance of the photovoltaic power generation component, δ represents the power temperature correction coefficient, T_{TRC} represents the rated battery temperature value of the photovoltaic power generation component, and T_{cell} represents the linear fitting function;
a photovoltaic power value prediction module configured for predicting a photovoltaic power value of the photovoltaic power generation component to be predicted by the third photovoltaic power prediction model and determining a target weather correction coefficient from a plurality of weather correction coefficients according to a weather type of the photovoltaic power generation component to be predicted.

5. A computer device, comprising a memory and a processor, wherein the memory and the processor are connected in communication with each other, a computer instruction is stored in the memory, and the processor executes the computer instruction, thereby executing:
generating a second photovoltaic power prediction model by correcting a first photovoltaic power prediction model based on a correction coefficient, comprising:
$${p}_{p r e d 2} = ( 1 - {K}_{1} - {K}_{2} - {K}_{3} ) {p}_{p r e d T a r g} \times \frac{{G}_{m e a s}}{{G}_{T R C}} \times [ 1 + δ ( {T}_{1} - {T}_{TRC} ) ] ;$$
wherein, p_{pred2} represents a photovoltaic power value output by the second photovoltaic power prediction model, K₁ represents a dust influence coefficient, K₂ represents a light-induced attenuation loss coefficient in an initial state, K₃ represents a surface reflection loss coefficient, p_{predTarg} represents a photovoltaic rated power value of a photovoltaic power generation component, Gₘₑₐₛ represents a measured irradiance of the photovoltaic power generation component, G_{TRC} represents a rated irradiance of the photovoltaic power generation component, δ represents a power temperature correction coefficient, T₁ represents a measured battery temperature value of the photovoltaic power generation component, and T_{TRC} represents a rated battery temperature value of the photovoltaic power generation component;
wherein the first photovoltaic power prediction model is constructed based on a battery temperature and an irradiance of the photovoltaic power generation component;
judging whether environment temperature information of the photovoltaic power generation component to be predicted meets preset requirement information; in a case that the environment temperature information does not meet the preset requirement information, determining an average battery temperature value of the photovoltaic power generation component to be predicted and a first relationship, wherein the first relationship represents a relationship among the battery temperature, an environment temperature and the irradiance of the photovoltaic power generation component to be predicted;
generating a third photovoltaic power prediction model by correcting the second photovoltaic power prediction model based on the average battery temperature value and the first relationship, comprising:
performing primary correction on the second photovoltaic power prediction model based on the average battery temperature value, wherein determining the average battery temperature value of the photovoltaic power generation component to be predicted, comprises:
acquiring all battery temperature values of the photovoltaic power generation component to be predicted in a preset time period;
removing battery temperature values with irradiance less than a preset threshold from all the battery temperature values; and
determining the average battery temperature value according to remaining battery temperature values;
performing the primary correction on the second photovoltaic power prediction model based on the average battery temperature value, comprises:
$${p}_{p r e d 3} = ( 1 - {K}_{1} - {K}_{2} - {K}_{3} ) {p}_{p r e d T a r g} \times \frac{{G}_{m e a s}}{{G}_{T R C}} \times [ 1 + δ ( {T}_{2} - {T}_{TRC} ) ] ;$$
wherein, p_{pred3} represents a photovoltaic power value output by a result of the primary correction, K₁ represents the dust influence coefficient, K₂ represents the light-induced attenuation loss coefficient in the initial state, K₃ represents the surface reflection loss coefficient, p_{predTarg} represents the photovoltaic rated power value of the photovoltaic power generation component, Gₘₑₐₛ represents the measured irradiance of the photovoltaic power generation component, G_{TRC} represents the rated irradiance of the photovoltaic power generation component, δ represents the power temperature correction coefficient, T₂ represents the average battery temperature value, and T_{TRC} represents the rated battery temperature value of the photovoltaic power generation component;
performing secondary correction on the result of the primary correction based on the first relationship, and generating the third photovoltaic power prediction model, wherein the first relationship is a linear fitting function; and determining the first relationship of the photovoltaic power generation component to be predicted comprises:
acquiring a plurality of battery temperature values of the photovoltaic power generation component to be predicted in the preset time period, a plurality of environment temperature values corresponding to the plurality of battery temperature values one by one, and a plurality of irradiance values corresponding to the plurality of battery temperature values one by one; and
obtaining the linear fitting function for representing that a difference between the battery temperature value and the environment temperature value has a linear relationship with the irradiance based on the plurality of battery temperature values, the plurality of environment temperature values and the plurality of irradiance values:
$${T}_{c e l l} = {T}_{a} + ( {T}_{N O C T} - {T}_{a , N O C T} ) \cdot ( H / {G}_{N O C T} ) \cdot ( 1 - ( η / τ a ) ) ;$$
wherein, T_{cell} represents the battery temperature value, Tₐ represents the environment temperature value, T_{NOCT} represents a battery piece temperature under an NOCT condition, T_{a,NOCT} represents an environment temperature under the NOCT condition, which is 20° C., H represents a solar irradiance on a matrix plane, and G_{NOCT} represents an irradiance under the NOCT condition, which is 800 W/m²; and η/τa represents 0.083/0.9, which is a default constant;
performing the secondary correction on the result of the primary correction based on the first relationship, and generating the third photovoltaic power prediction model, comprises:
$${p}_{p r e d 4} = ( 1 - {K}_{1} - {K}_{2} - {K}_{3} ) {p}_{p r e d T a r g} \times \frac{{G}_{m e a s}}{{G}_{T R C}} \times [ 1 + δ ( {T}_{c e l l} - {T}_{T R C} ) ] ;$$
wherein, p_{pred4} represents the photovoltaic power value output by the second photovoltaic power prediction model, K₁ represents the dust influence coefficient, K₂ represents the light-induced attenuation loss coefficient in an initial state, K₃ represents the surface reflection loss coefficient, p_{predTarg} represents the photovoltaic rated power value of the photovoltaic power generation component, Gₘₑₐₛ represents the measured irradiance of the photovoltaic power generation component, G_{TRC} represents the rated irradiance of the photovoltaic power generation component, δ represents the power temperature correction coefficient, T_{TRC} represents the rated battery temperature value of the photovoltaic power generation component, and T_{cell} represents the linear fitting function;
predicting a photovoltaic power value of the photovoltaic power generation component to be predicted using the third photovoltaic power prediction model; and
according to a weather type of the photovoltaic power generation component to be predicted, determining a target weather correction coefficient from a plurality of weather correction coefficients.

6. A computer-readable storage medium, wherein the computer-readable storage medium stores a computer instruction thereon, and the computer instruction is used to enable a computer to execute the method for predicting photovoltaic power according to claim 1.

7. The computer device according to claim 5, wherein the photovoltaic power value is adjusted based on the target weather correction coefficient to obtain a target photovoltaic power value.

8. The computer device according to claim 7, wherein, before determining the target weather correction coefficient from the plurality of weather correction coefficients, the method comprises:
acquiring multiple groups of data of the photovoltaic power generation component to be predicted under different weather types in advance, wherein each group of data comprises an installed capacity, an irradiance value, a battery temperature value and an actual power generation capacity under a corresponding weather type; and
determining the target weather correction coefficient of a corresponding weather type by inputting the installed capacity, the irradiance value, the battery temperature value and the actual power generation capacity under the corresponding weather type into a correction coefficient prediction model.

9. The computer-readable storage medium according to claim 6, wherein the photovoltaic power value is adjusted based on the target weather correction coefficient to obtain a target photovoltaic power value.

10. The computer-readable storage medium according to claim 9, wherein, before determining the target weather correction coefficient from the plurality of weather correction coefficients, the method comprises:
acquiring multiple groups of data of the photovoltaic power generation component to be predicted under different weather types in advance, wherein each group of data comprises an installed capacity, an irradiance value, a battery temperature value and an actual power generation capacity under a corresponding weather type; and
determining the target weather correction coefficient of a corresponding weather type by inputting the installed capacity, the irradiance value, the battery temperature value and the actual power generation capacity under the corresponding weather type into a correction coefficient prediction model.
